(19) United States
(12) Patent Application Publication
(10) Pub. No.: US 2010/0150432 A1
(43) Pub. Date: Jun. 17, 2010

(54) METHOD AND MACHINE FOR DIGITALLY CATALOGUING ARTICLES

(75) Inventor: Mirko Zilli, San Martino (IT)

Correspondence Address: VENABLE LLP, P.O. BOX 34385, WASHINGTON, DC, 20043-9998, US

(73) Assignee: Crea Solution S.R.L., Anzola dell' Emillia (IT)

(21) Appl. No.: 12/440,209

(22) PCT Filed: Sep. 4, 2007
(86) PCT No.: PCT/IB2007/002552

§ 371 Date: Sep. 21, 2009

(30) Foreign Application Priority Data
Sep. 5, 2006 (IT) BO2006A000624

(51) Int. Cl. G06K 9/62; G09G 5/00

(52) U.S. Cl. 382/159; 345/650

(57) ABSTRACT

Method for digitally cataloguing articles, in which a revolving support supports an article and turns it around a vertical axis of rotation, a plurality of images of the article are acquired synchronously with its rotation y two digital cameras positioned at respective observation points on a fixed structure, the acquired images of the article are filed in an image database, the filed images are made-up together with information pertinent to the article extracted from a stock control program of the articles to catalogue, and the thus made-up pages are published on the Internet.

### TECHNICAL FIELD

The present invention concerns a method and a corresponding machine for digitally cataloguing articles.

In particular, the present invention finds advantageous, but not exclusive, application in the automatic cataloguing and publishing of articles for the fashion industry on the Internet, to which the description that follows shall make explicit reference, but without any loss of generality.

### BACKGROUND ART

As is known, articles of clothing or leatherwear are produced on models that rapidly evolve in time. In an increasingly global industry such as that of fashion, it becomes important to exploit every commercial opportunity through whatever information channel, for example, by publishing a catalogue on the Internet.

The publication of a catalogue on the Internet is, at present, carried out with the aid of special agencies that take care of the creation and publication of catalogues on the Internet, with the photographs of the articles being supplied to these agencies. Interaction with these agencies entails significant costs in terms of money and time and the consequent risk of publishing an already outdated catalogue.

### DISCLOSURE OF INVENTION

The object of present invention is to provide a method and a machine for digitally cataloguing fashion industry articles, this method and machine being devoid of the above-described drawbacks and, at the same time, of straightforward and economic embodiment.

According to the present invention, a method and a machine for digitally cataloguing articles are provided in accordance with that defined in the enclosed claims.

### BRIEF DESCRIPTION OF THE DRAWINGS

The present invention will now be described with reference to the enclosed drawings that illustrate a non-limitative example of embodiment, in which:

FIG. 1 illustrates the machine for digitally cataloguing articles according to the present invention, and

FIG. 2 schematically illustrates a modular architecture of software that can be loaded and executed on a computer forming part of the machine in FIG. 1 and implementing the method for digitally cataloguing articles according to the present invention.

### BEST MODE FOR CARRYING OUT THE INVENTION

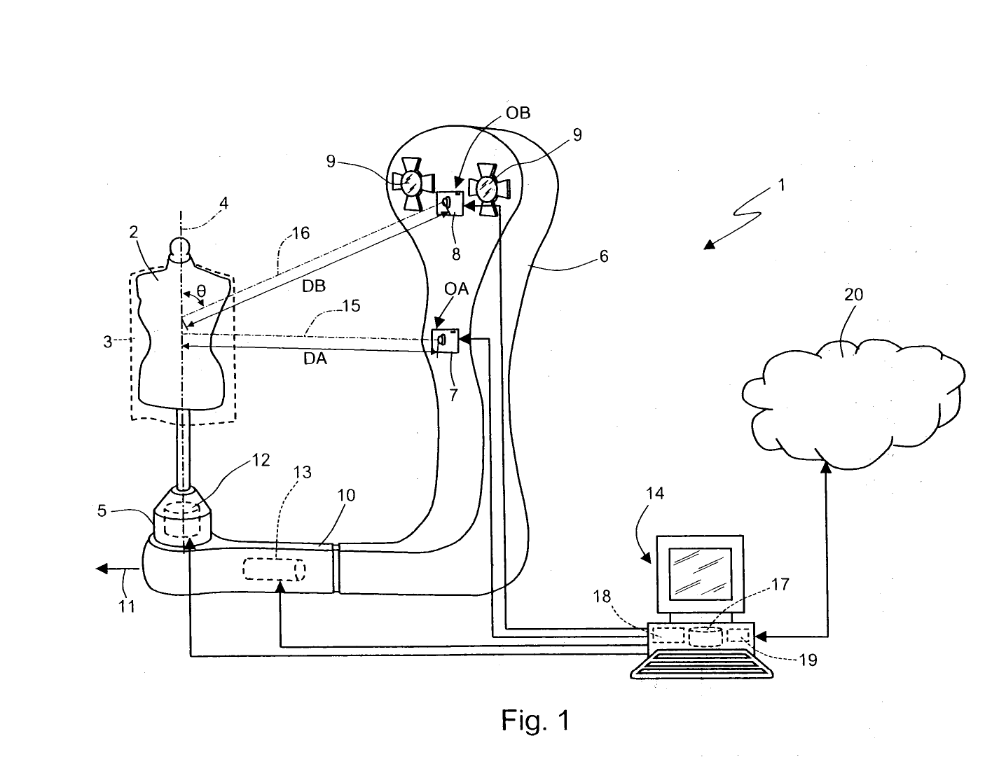

In FIG. 1, reference numeral 1 generically indicates a machine for digitally cataloguing articles in its entirety.

The machine 1 includes a revolving support 2 able to support an article 3, that is shown by a dashed line, and turn the article 3 around a vertical axis of rotation 4 passing through the body of the article 3; a pedestal 5 on which the revolving support 2 is mounted; a substantially vertical fixed structure placed in front of the revolving support 2; two image acquisition devices 7 and 8 mounted on the fixed structure 6 to acquire a plurality of images of the article 3 placed on the revolving support 2 from two respective vertically aligned observation points OA and OB; a pair of spotlights 9 directed to illuminate the article 3; and an arm 10 extendable in a direction of adjustment 11 transversal and, in particular, perpendicular to the axis of rotation 4 to connect the pedestal 5 to the fixed structure 6 in order to be able to adjust the distance of the axis of rotation 4 from the observation points OA and OB.

In addition, the machine 1 includes a motor unit 12 housed inside the body of the pedestal 5 able to set the revolving support 2 in rotation; an actuator unit 13 housed inside the body of the arm 10 to operate the extension or retraction of the arm 10; and a processing and control unit 14 connected to the image acquisition devices 7 and 8, the motor unit 12 and the actuator unit 13 to control their operation.

The revolving support 2 shown in FIG. 1 is composed of a tailor's dummy for the purpose of fitting the article 3, consisting of an item of clothing. The revolving support 2 is interchangeable, in the sense that it can be alternatively substituted with another type of revolving support 2 composed of a simple revolving platform (not shown) to support, for example, a pair of shoes, a woman's handbag or any other article to be catalogued (not shown).

The two image acquisition devices 7 and 8 consist, for example, of respective digital cameras, or respective digital video cameras. Alternatively, one of the two image acquisition devices 7 and 8 consists of a camera and the other consists of a digital video camera.

A first one of the two image acquisition devices, indicated by reference numeral 7, is positioned in observation point OA with its own optical axis 15 pointing perpendicular to the axis of rotation 4 to allow the acquisition of at least a side-view image of the article 3. The other image acquisition device 8 is positioned in observation point OB with its own optical axis 16 pointing transversely to the axis of rotation 4 to allow the acquisition of at least a perspective-view image of the article 3. In particular, the optical axis 16 forms an angle θ of 45 degrees with the axis of rotation 4.

The axis of rotation 4 is positioned at a distance DA from the observation point OA in the direction of the optical axis 15 and at a distance DB from observation point OB in the direction of the optical axis 16. The arm 10 is sized such that the distance DA can be varied in an interval between 1.5 and 5 metres. The value of the distance DB is determinable as a function of the value of the distance DA and the value of said angle θ by means of a simple geometric relation.

The processing and control unit 14 is composed of, for example, a personal computer including a storage unit 17, a processing unit 18 and a communications unit 19 for connection to the Internet 20.

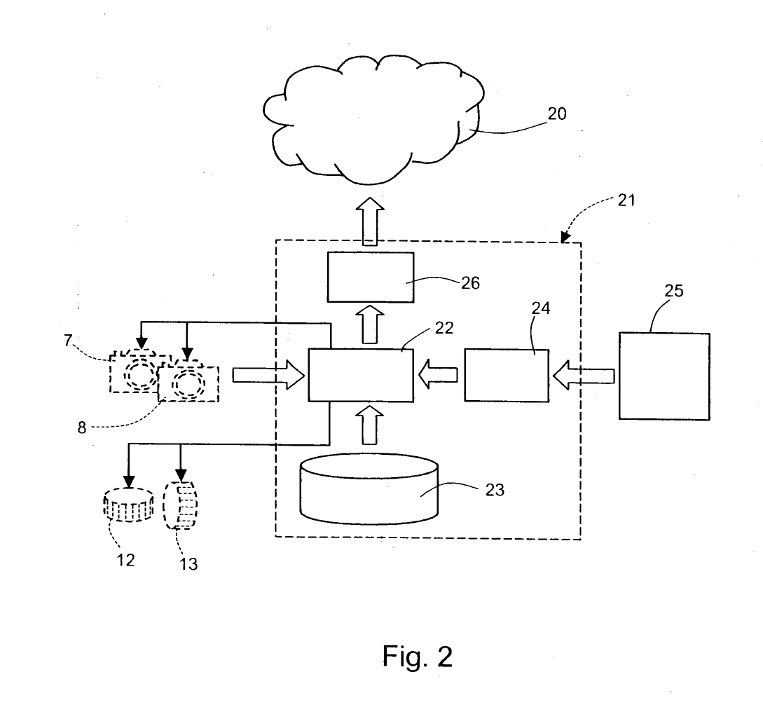

A cataloguing program 21, based on a modular architecture shown in FIG. 2, is loaded on the processing unit 18.

In particular, with reference to FIG. 2, the cataloguing program 21 is conceptually subdivisible into the following software modules:

a cataloguing module 22 for the control of the motor unit 12, the actuator unit 13 and the image acquisition devices, the subsequent reception of the acquired images and the processing of the received images in order to create a digital-format catalogue;

an image database module 23 for the filing of the acquired images, according to certain criteria;

an interface module 24 for interfacing with a stock control program 25 to extract inventory information on the articles to be catalogued; and

a publishing module 26 for the publication of this catalogue on a page on an Internet site, so that a remote user can make use of the images and information.

In use, the cataloguing module 22 provides for initially adjusting the distance DA, and consequently the distance DB, by operation of the arm 10, according to the dimensions of the article 3 with respect to the field of view of the image acquisition devices 7 and 8.

After making this adjustment, the cataloguing module 22 starts to turn the revolving support 2, activating the image acquisition devices 7 and 8 in a synchronised manner with this rotation to acquire a plurality of images of the article 3 placed on the revolving support 2, receiving this plurality of images and filing them in the image database module 23. The image database module 23 is installed and stored on the storage unit 17.

In the case under consideration, in which the article 3 consists of an item of clothing, filing can take place, for example, by colour, by model, by season when used, etc.

The mode of turning the revolving support 2 depends on the types of the image acquisition devices 7 and 8 used and can thus be of at least two types. In the case of using cameras, the revolving support 2 is made to turn in steps around the axis of rotation 4 between a plurality of set positions until it completes an entire revolution and the cameras are activated at each step, when the revolving support is stationary, to acquire at least one image of the article 3 placed on the revolving support 2. Instead, in the case where video cameras are used, the revolving support 2 is made to turn continuously around the axis of rotation 4 until it completes an entire revolution and the video cameras are activated during the entire revolution to acquire a video clip, in other words a sequence of images, of the article 3 placed on the revolving support 2.

At this point, the cataloguing module 22 processes the plurality of acquired images associating information pertinent to the article 3 under consideration, for example, the name of the model, stock levels by colour and size, price, etc. to the plurality of images; transforming this information into text; and making up this text content together with the plurality of images.

Information pertinent to the article 3 is extracted by the stock control program 25 via the interface module 24, which transfers this information to the image database module 23 so that it can be used by the cataloguing module 22.

The stock control program 25 can be loaded on the processing unit 18, or be loaded on another computer (not shown) that is linked to the processing and control unit 14.

Finally, the publishing module 26 takes care of transferring the plurality of images made up together with the text content to a page on the Internet site identified by a respective URL (Uniform Resource Locator) address. The transfer takes place using known network data transfer protocols, for example, the HTTP protocol or the FTP protocol. The publishing module 26 also provides a partial transfer mode, in which the mentioned text content is simply updated with the latest information regarding the article 3.

According to another embodiment that is not shown, the machine 1 is devoid of the actuator unit 13 inside the body of the arm 10 and so the cataloguing module 22 of the cataloguing program loaded on the processing unit 18 no longer provides for activating the extension of the arm 10 to adjust the distances DA and DB when in use. The extension of the arm 10, and consequently the adjustment of the distances DA and DB, is manually performed by an operator after the article 3 has been arranged on the revolving support 2.

The main advantage of the above-described machine 1 is of automation, and therefore speeding up the process of cataloguing and publishing fashion industry articles on the Internet. For example, by using this machine 1, a fashion company can publish new models of articles every day on the Internet, effectively informing potential customers who use the Internet on the stock availability of these articles in real time.

It follows that it is no longer necessary to use the services of special catalogue creation and publication agencies, with consequent savings in time and money.

1. Method for digitally cataloguing articles, the method comprising:
turning at least one article around a given axis of rotation;
acquiring a plurality of images of the article in digital form in a manner synchronized with the rotation of article from at least one fixed observation point;
storing the plurality of images of the article in an image database; and
processing the plurality of images of the article so as to render these images usable by a remote user.

2. Method according to claim 1, in which turning the article comprises:
turning the article in steps between a plurality of set positions until an entire revolution of the article is completed around said axis of rotation; and
acquiring a plurality of images of the article comprises:
acquiring an image of the article at each step of rotation when the article is stationary.

3. Method according to claim 1, in which turning the article comprises:
turning the article continuously until an entire revolution of the same article is completed around said axis of rotation; and
acquiring a plurality of images of the article comprises:
acquiring a video clip of the article during its rotation, the video clip being defined by a sequence of images.

4. Method according to claim 1, in which acquiring a plurality of images of the article comprises:
acquiring at least a side-view image of the article from a first fixed observation point in a first direction of observation perpendicular to said axis of rotation.

5. Method according to claim 4, in which acquiring a plurality of images of the article comprises:
acquiring at least a perspective-view image of the article from a second fixed observation point in a second direction of observation transversal to said axis of rotation.

6. Method according to claim 5, in which said second direction of observation forms an observation angle (θ) of 45 degrees with said axis of rotation.

7. Method according to claim 5, in which said axis of rotation is positioned at a first distance from said first fixed observation point in said first direction of observation and at a second distance from said second observation point in said second direction of observation; the method also comprising:
adjusting the value of the first and second distance according to the dimensions of the article.

8. Method according to claim 7, in which the value of said first distance is adjustable within an interval between 1.5 and 5 metres and the value of said second distance is defined as a function of the value of the first distance and said observation angle (θ).

9. Method according to claim 1, in which processing the plurality of images of the article comprises:
associating information pertinent to said article to said plurality of images;
transforming said information into text content understandable to said remote user; and
making up the plurality of images of the article together with said text content.

10. Method according to claim 9, in which associating information pertinent to said article to said plurality of images comprises:
extracting this information from a stock control program that collects information on the articles to be catalogued.

11. Method according to claim 9, also comprising:
transferring said plurality of images made up with said text content to a location on the Internet identified by a given address (URL).

12. Machine for digitally cataloguing articles comprising mobile support means able to support at least one article, to turn the article around a given axis of rotation and to move the article with respect to at least one fixed observation point in a direction of adjustment transversal to the axis of rotation; drive means for operating the rotation and movement of the mobile support means; image acquisition means positioned in correspondence to said at least one fixed observation point to acquire a plurality of digital images of the article during its rotation; and processing and control means, which are connected to the image acquisition means and to the drive means and are configured to implement the method for digitally cataloguing articles according to claim 1.

13. Machine according to claim 12, comprising fixed support means able to support said image acquisition means positioned in correspondence to said at least one fixed observation point; said mobile support means comprising a revolving support to support and to turn said article around said axis of rotation, and an arm extensible in said direction of adjustment to change the distance between the axis of rotation and said fixed support means.

14. Machine according to claim 12, in which said image acquisition means comprise a first image acquisition device, which is positioned in said first fixed observation point and has a first optical axis pointing perpendicular to said axis of rotation.

15. Machine according to claim 14, in which said means of image acquisition comprise a second image acquisition device, which is positioned in said second fixed observation point and has a second optical axis pointing transversally to said axis of rotation.

16. Machine according to claim 15, in which said first or second image acquisition device comprises a camera to acquire at least one image of said article each time the article is stationary.

17. Machine according to claim 15, in which said first or second image acquisition device comprises a video camera to acquire a video clip of said article during the continual rotation of the article.

18. Machine according to claim 12, in which said processing and control means comprise a storage unit to store said image database, and a communications unit for connection with the Internet.
